(19) United States
(12) Patent Application Publication
(10) Pub. No.: US 2015/0268457 A1
(43) Pub. Date: Sep. 24, 2015

(54) IMAGE PICKUP APPARATUS

(71) Applicant: CANON KABUSHIKI KAISHA, Tokyo (JP)

(72) Inventor: Kazuhiko Kajiyama, Utsunomiya-shi (JP)

(21) Appl. No.: 14/643,204

(22) Filed: Mar. 10, 2015

(30) Foreign Application Priority Data
Mar. 18, 2014 (JP) 2014-055090

(51) Int. Cl. G02B 21/00; H04N 5/235; G02B 17/08; G02B 21/36; G02B 21/12

(52) U.S. Cl. CPC G02B 21/008; G02B 21/36; G02B 21/12; G02B 17/0808; H04N 5/2354

(57) ABSTRACT

An image-pickup apparatus includes an illumination optical system, an imaging optical system, and an image sensor. The illumination optical system includes an adjustable diaphragm configured to adjust a light quantity of the excited light. The imaging optical system includes a light shield arranged at a position conjugate with a position of the adjustable diaphragm, and configured to shield light on and around an optical axis. A·M<B≦1.3A·M is satisfied, where A is an aperture diameter of the adjustable diaphragm, B is a diameter of the light shield, and M is an imaging magnification of an optical system that includes part of the illumination optical system between the adjustable diaphragm and the light shield, and part of the imaging optical system between the adjustable diaphragm and the light shield.

### BACKGROUND OF THE INVENTION

1. Field of the Invention

The present invention relates to an image-pickup apparatus.

2. Description of the Related Art

Due to the virtual microscope that captures image data of a pathologic specimen and enables it to be observed on a display, a plurality of persons can simultaneously observe the image and a patient can have himself examined by a remote doctor. In capturing image data of a large pathologic specimen using a narrow image pickup area of the microscope, it is necessary to divide the pathologic specimen into a plurality of areas, to capture an image of each area the plurality of times, and to form one image by connecting these divided images, causing a long image pickup time. Accordingly, the microscope is required to use an objective lens having a wide image pickup area. Japanese Patent Laid-Open No. 2011-232610 proposes a catadioptric optical system for an objective lens. A fluorescent microscope configured to irradiate excited light onto a sample and observe the fluorescent light from the sample has recently attracted attentions, and this fluorescent microscope is demanded for a smaller configuration.

However, the fluorescent microscope configured as a transmission type is likely to become large when its illumination optical system that illuminates a sample with excited light has a numerical aperture higher than that of the objective lens. An epi-illumination type that uses part of the objective lens for the illumination optical system has a low design freedom because the objective lens needs a dichroic mirror and a dichroic prism, and consequently it becomes difficult for the objective lens to have a wide image pickup area. Moreover, the fluorescent microscope needs a means for preventing the excited light from entering the image sensor.

### SUMMARY OF THE INVENTION

The present invention provides an image pickup apparatus configured to secure a wide image pickup area with a small configuration and to prevent excited light from entering an image sensor.

An image-pickup apparatus according to the present invention includes an illumination optical system configured to illuminate a sample with excited light, an imaging optical system configured to form an optical image of the sample using fluorescent light from the sample, and an image sensor configured to photoelectrically convert an optical image formed by the imaging optical system. The illumination optical system includes an adjustable diaphragm configured to adjust a light quantity of the excited light. The imaging optical system includes a light shield arranged at a position conjugate with a position of the adjustable diaphragm, and configured to shield light on and around an optical axis. A condition of A·M<B≦1.3A·M is satisfied, where A is an aperture diameter of the adjustable diaphragm, B is a diameter of the light shield, and M is an imaging magnification of an optical system that includes part of the illumination optical system between the adjustable diaphragm and the light shield, and part of the imaging optical system between the adjustable diaphragm and the light shield.

Further features of the present invention will become apparent from the following description of exemplary embodiments with reference to the attached drawings.

### BRIEF DESCRIPTION OF THE DRAWINGS

FIG. 1 is a block diagram of a fluorescent microscope according to this embodiment.

FIG. 2 is a view of a structure for fluorescent observation in the fluorescent microscope illustrated in FIG. 1.

FIGS. 3A and 3B are plane view of an illustrative light shield illustrated in FIG. 1.

FIG. 4 is a schematic sectional view of an objective lens according to this embodiment.

FIG. 5 is a lateral aberrational diagram of the objective lens according to this embodiment.

### DESCRIPTION OF THE EMBODIMENTS

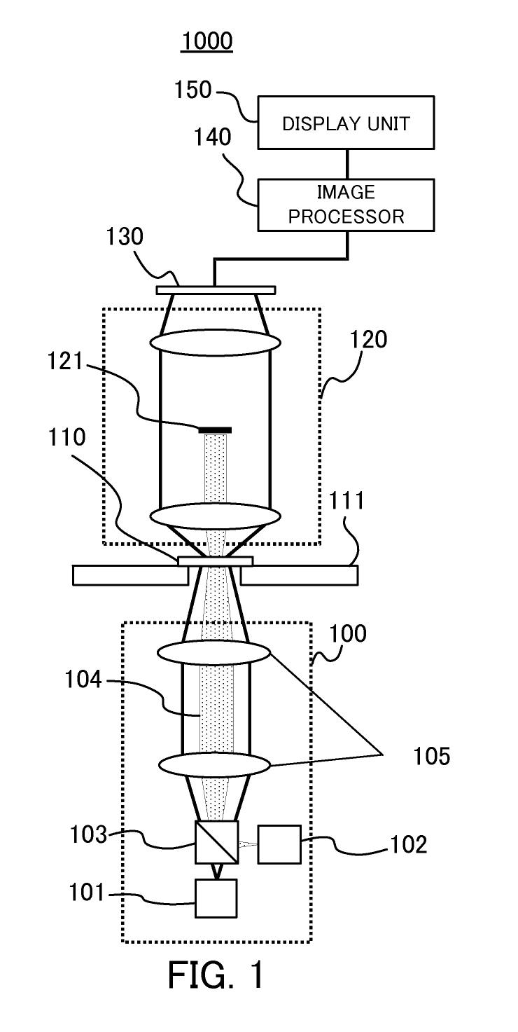

FIG. 1 is a block diagram of a fluorescent microscope (image-pickup apparatus) 1000 according to this embodiment. The image-pickup apparatus 1000 includes an illumination optical system 100, a holder 111 configured to hold a sample 110, an objective lens 120, an image sensor 130, an image processor 140 configured to generate image information from an output of the image sensor 130, and a display unit 150, such as a display, configured to display an image.

The illumination optical system 100 illuminates the sample 110 with light from a light source 101 for bright-field observation, and light from a light source 102 for fluorescent observation, and includes a dichroic prism 103 and a condenser lens 105.

The light source 101 for bright-field observation emits visible light having a wavelength, for example, from 400 nm to 700 nm inclusive, and a direction of a principal ray is aligned with the optical axis of the illumination optical system 100. The light source 102 for fluorescent observation emits excited light having a wavelength, for example, of about 450 nm. The dichroic prism 103 transmits the light from the light source 101 for bright-field observation and reflects the light from the light source 102 for fluorescent observation. The condenser lens 105 condenses the light from each light source onto the sample 110.

The objective lens 120 is an imaging optical system configured to form an image of the illuminated sample on the image sensor 130 with a wide angle of view and a high resolution. The objective lens 120 may be a catadioptric optical system, which will be described later. A light shield 121 in the objective lens 120 shields light among the excited light 104 from the light source 102 for fluorescent observation, which has transmitted through the sample 110, has not been converted into fluorescent light, and has not changed its traveling path. The light shield 121 is arranged at a position conjugate with the adjustable diaphragm 106, which will be described later, and shields light on and around the optical axis. This embodiment shields excited light as 0^{th} order light which has not changed its traveling path, because deflected light among the excited light which has transmitted the sample 110 has a low intensity.

The image processor 140 generates image data from the signal (image information) obtained by the image sensor 130, and the display unit 150 displays the generated image data. The image processor 140 provides various processing with the use, such as correcting an aberration that has not yet been corrected by the imaging optical system 120, and synthesizing image data at different image pickup positions into one sheet of image data.

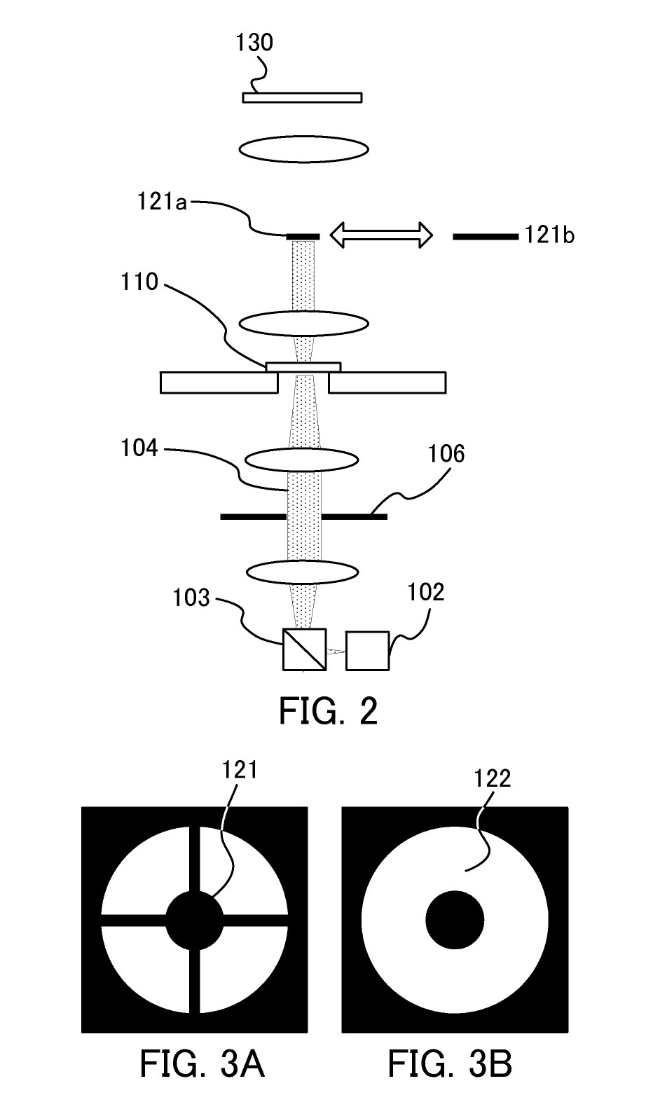

FIG. 2 is a view illustrating a concrete structural example of each of the illumination optical system 100 and the objective lens 120 for fluorescent observation in the fluorescent microscope. The illumination optical system 100 further includes an adjustable diaphragm 106 configured to correct a light quantity, and the light shield 121 includes light shields 121a and 121b having different sizes and replaceable with each other by a turret etc. The adjustable diaphragm 106 is arranged at a position conjugate with the light shield 121. The turret is one type of a mover configured to move one of a plurality of light shields to the optical axis of the imaging optical system according to an aperture diameter of the adjustable diaphragm 106.

The excited light from the light source 102 for fluorescent observation is led to the condenser lens 105 in the illumination optical system by the dichroic prism 103. The sample is illuminated with a low NA by making narrower the adjustable diaphragm 106 than that for bright-field observation. The 0^{th} order light of the excited light 104 passes an area that contains the optical axis of the objective lens 120 by narrowing the adjustable diaphragm 106, and shielded by the light shield 121 arranged on the area that contains the optical axis of the objective lens 120. The light shield 121 may be exchanged according to the F-number of the adjustable diaphragm 106. For example, when a large light amount of the excited light is necessary, the adjustable diaphragm 106 is widely opened and the turret sets the larger light shield 121b. In order to shield 0^{th} order light of the excited light, the following conditional expression may be satisfied.

A·M<B≦1.3A·M

Herein, A (mm) is an aperture diameter of the adjustable diaphragm 106. B (mm) is a diameter of the light shield 121. M is an imaging magnification of an optical system that includes part of the illumination optical system 100 between the adjustable diaphragm 106 and the light shield 121, and part of the objective lens 120 between the adjustable diaphragm 106 and the light shield 121.

FIGS. 3A and 3B are plane views of the illustrative light shields 121. The light shield 121 may be supported by a spider as illustrated in FIG. 3A. In shielding the deflected light other than the 0^{th} order light of the excited light, a light shielding material may mask a surface of plane glass as illustrated in FIG. 3B and a light transmitting part 122 may be coated with a film configured to cut or absorb the excited light.

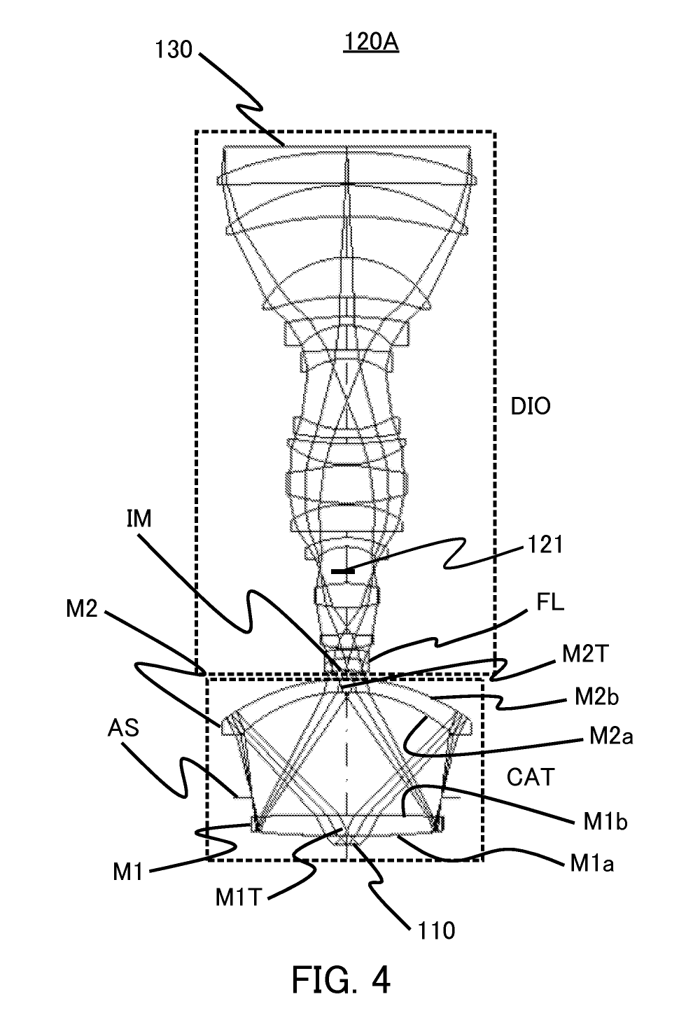

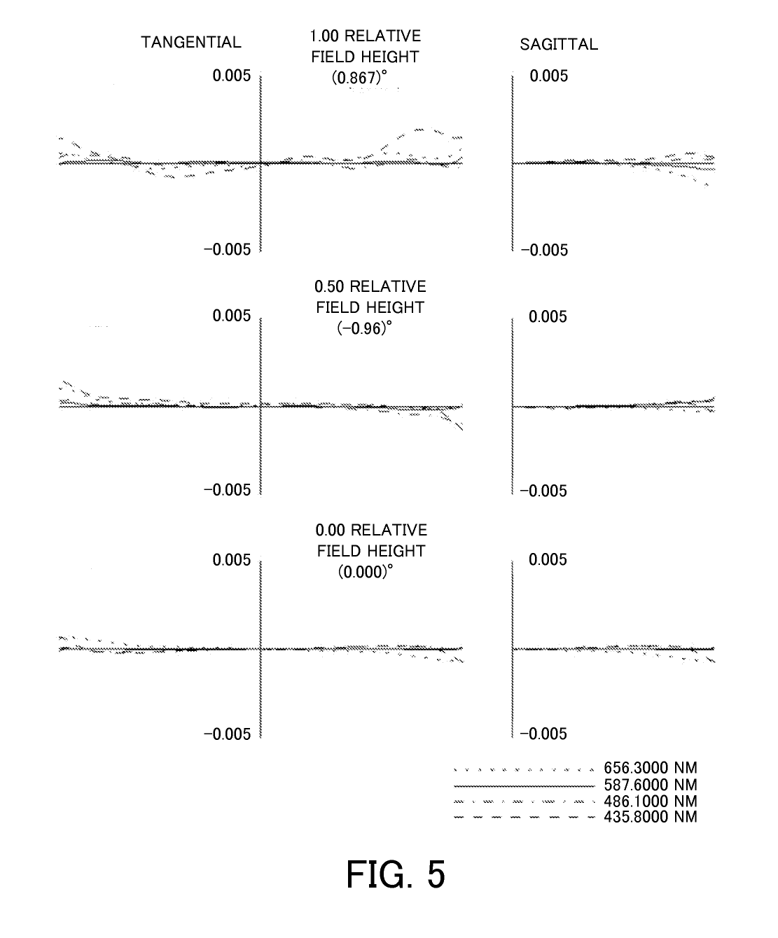

FIG. 4 is a sectional view of principal part of the objective lens 120A according to this embodiment. FIG. 5 is lateral aberrational diagrams of the objective lens 120A. In the lateral aberration diagrams, the aberrations are calculated on the sample 110 and represented in millimeter unit. Wavelengths of 656.3 nm, 486.1 nm, and 435.8 nm are illustrated as well as the central wavelength of 587.6 nm. It is understood that the aberrations are restrained in a wide wavelength range.

The objective lens 120A may use a catadioptric optical system illustrated in FIG. 4 that forms the image twice. The aperture diaphragm AS and the light shield 121 may be arranged on the pupil plane in the objective lens 120A, but a twice imaging type catadioptric optical system enables them to be arranged at two different positions. When the objective lens 120A includes a once imaging type optical system, it is necessary to arrange the aperture diaphragm AS and the light shield 121 at the same position and the arrangement becomes mechanically difficult. When a dioptric optical system is used to configure the twice imaging type, the overall length becomes longer. This is because the effect of the Pezval sum oppositely affects between the reflective surface and the refractive surface.

The objective lens 120A includes a catadioptric unit CAT and a dioptric part DIO. The catadioptric unit CAT includes at least two optical elements, i.e., a first optical element M1 and a second optical element M2 in order from the object side. The first optical element M1 has a light transmitting area M1T (first light transmitting area) having a convex shape on a surface M1a on the object side and a positive refractive power on and around the optical axis, and a reflection film in the periphery of the surface M1a on the object side so as to provide a reflective rear surface (first reflective area). The second optical element M2 includes a concave surface on the object side, and a light transmitting area M2T (second light transmitting area) having a meniscus shape and a negative refractive power on and around the optical axis, and a reflection film in the periphery of the surface M2b so as to provide a reflective rear surface (second reflective area). The first optical element M1 and the second optical element M2 are arranged so that their reflective rear surfaces oppose to each other.

In other words, the first optical element M1 has the convex surface on the sample (object) 110 side, and the light transmitting area M1T having a positive refractive power around the optical axis. The reflection film is formed onto the periphery of the surface M1a on the object side so as to provide the reflective rear surface. The second optical element M2 has the concave surface on the sample (object) 110 side, and the light transmitting area M2T having the meniscus shape and the negative refractive power around the optical axis. The reflection film is formed onto the periphery of the surface M2b on the image side so as to provide the reflective rear surface. The dioptric part DIO includes the light shield 121 that shields light on and around the optical axis among the light from the sample 110 and prevents the light from entering the image sensor 130.

In the objective lens 120A, the fluorescent light excited by the light from the illumination optical system 100 and emitted from the sample 110 passes the central transmitting area M1T in the first optical element (Mangin mirror) M1. Thereafter, the fluorescent light enters the refractive surface M2a of the second optical element (Mangin mirror) M2, is reflected on the rear surface M2b, passes the reflective surface M2a, and enters the refractive surface M1b of the first optical element M1. Then, the fluorescent light is reflected on the rear surface Mia of the first optical element M1, passes the refractive surface M1b and the central transmitting area M2T of the second optical element M2, and forms an intermediate image IM of the sample 110. An enlarged image of the intermediate image IM is reimaged on the image sensor 130 by the dioptric part DIO that includes a plurality of refractive optical elements. The image of the sample 110 formed on the image sensor 130 is processed by the image processor 140 and displayed on the display unit 150.

The objective lens 120A has a numerical aperture NA of 0.7 on the sample side, an imaging magnification of 10 times, an object height of φ14 mm of the sample 110. The aperture diaphragm AS is arranged in the catadioptric part CAT, and the light shield 121 is arranged in the dioptric part DIO. The aperture diaphragm AS arranged in the catadioptric part CAT can reduce the distortion of the pupil although the diaphragm diameter becomes larger than that for the aperture diaphragm arranged in the dioptric part. The objective lens 120A is telecentric both at the object side and at the image side, and the worst value of the wavefront aberration of the white light is restrained down to 50 mλ (rms) or less.

A numerical example of the objective lens 120 will now be given. The surface number represents an order of the optical surface counted from the object plane (sample) to the image plane (image sensor). “r” is a radius of curvature of the i-th optical surface. “d” is an interval between the i-th optical surface and the (i+1)-th optical surface where a sign is positive for a measurement in a (light traveling) direction from the object plane to the image plane, and negative for a measurement in the reverse direction.

Nd and νd are a refractive index and an Abbe number of a material to the wavelength of 587.6 nm. An aspheric shape is represented by the following general expression for the aspheric surface. In the following expression, Z is a coordinate in the optical axis direction, c is a curvature (reciprocal of a radius of curvature), h is a height from the optical axis, k is a conical coefficient, a, b, c, d, e, f, g, h, i, . . . are aspheric coefficients for fourth order, sixth order, eighth order, tenth order, twelfth order, fourteenth order, sixteenth order, and eighteenth order, twentieth order, . . . , respectively. “E−X” means “10^{-X}.”

$$Z = \frac{{ch}^{2}}{1 + \sqrt{( 1 + k )} {c}^{2} {h}^{2}} + {ah}^{4} + {bh}^{6} + {ch}^{8} + {dh}^{10} + {eh}^{12} + {fh}^{14} + {gh}^{16} + {hh}^{18} + {ih}^{20} + …$$

### Numerical Example 1

| SURFACE NUMBER | r | d | Nd | νd |
|---|---|---|---|---|
| OBJECT PLANE | | 5.31 | | |
| 1 | 572.96 | 11.74 | 1.52 | 64.14 |
| 2 | −3971.93 | 70.93 | | |
| 3 | −87.05 | 7.37 | 1.58 | 40.75 |
| 4 | −115.96 | −7.37 | 1.58 | 40.75 |
| 5 | −87.05 | −60.93 | | |
| 6 | DIAPHRAGM | −10.00 | | |
| 7 | −3971.93 | −11.74 | 1.52 | 64.14 |
| 8 | 572.96 | 11.74 | 1.52 | 64.14 |
| 9 | −3971.93 | 70.93 | | |
| 10 | −87.05 | 7.37 | 1.58 | 40.75 |
| 11 | −115.96 | 4.40 | | |
| 12 | −280.62 | 7.55 | 1.73 | 45.75 |
| 13 | −24.25 | 5.00 | 1.76 | 27.58 |
| 14 | −63.13 | 0.50 | | |
| 15 | 44.30 | 8.03 | 1.62 | 60.32 |
| 16 | −134.04 | 15.13 | | |
| 17 | 64.29 | 14.17 | 1.56 | 58.80 |
| 18 | −57.90 | 8.93 | | |
| 19 | LIGHT SHIELD | 12.00 | | |
| 20 | −26.52 | 5.00 | 1.70 | 33.94 |
| 21 | −60.24 | 3.37 | | |
| 22 | 2035.38 | 15.68 | 1.63 | 35.46 |
| 23 | −70.44 | 0.89 | | |
| 24 | 117.93 | 21.53 | 1.68 | 39.58 |
| 25 | −74.17 | 0.50 | | |
| 26 | 56.79 | 12.02 | 1.74 | 30.97 |
| 27 | 177.00 | 3.06 | | |
| 28 | 165.39 | 5.00 | 1.76 | 27.58 |
| 29 | 53.42 | 40.67 | | |
| 30 | −38.60 | 5.00 | 1.76 | 27.58 |
| 31 | −229.85 | 13.99 | | |
| 32 | −35.70 | 5.00 | 1.76 | 27.58 |
| 33 | −181.79 | 11.22 | | |
| 34 | −143.30 | 22.66 | 1.52 | 53.64 |
| 35 | −56.43 | 23.57 | | |
| 36 | −219.04 | 17.88 | 1.75 | 34.24 |
| 37 | −110.37 | 1.09 | | |
| 38 | −4269.61 | 17.81 | 1.63 | 57.69 |
| 39 | −282.70 | 3.00 | | |
| IMAGE PLANE | | | | |

### Image Plane

For the light source 101 for bright-field observation, the objective lens 120 as the catadioptric optical system includes the catadioptric part CAT configured to condense the light from the sample 110 and to form the intermediate image IM of the object, a field lens FL arranged at or near a position in which the intermediate image IM is formed, and the dioptric unit DIO configured to reimage the intermediate image IM on the image plane (image sensor 130). The objective lens 120 forms an optical image of the sample 110. The image sensor 130 photoelectrically converts the optical image formed by the objective lens 120. The image processor 140 generates image information based on the data from the image sensor 130.

The light shield 121 shields the light on and around the optical axis among light from the sample 110, and prevents the light from entering the image sensor 130. The light flux emitted from the sample 110 transmits the central transmitting area M1T in the first optical element M1, then enters the refractive surface M2a of the second optical element M2, then is reflected on the rear surface M2b, passes the refractive surface M2a, and enters the refractive surface M1b of the first optical element M1. Thereafter, the light flux is reflected on the rear surface M1a of the first optical element M1, passes the refractive surface M1b and the central light transmitting area M2T of the second optical element M2, and forms the intermediate image IM of the sample 110. The intermediate image IM is formed inside the field lens FL. An enlarged image of the intermediate image IM is reimaged on the image sensor 130 by the dioptric part DIO that includes refractive optical elements. The image of the sample 110 formed on the image sensor 130 is processed by the image processor 140 and displayed on the display unit 150.

Assume that νcat is the smallest Abbe number among Abbe numbers of the materials of the first and second optical elements, and νdio is the smallest Abbe number among Abbe numbers of the materials of a plurality of refractive optical elements in the dioptric part DIO. Then, the following condition is satisfied.

νdio<νcat (1)

The Abbe number νcat and Abbe number νdio may satisfy at least one of the following conditions.

45<νcat (2)

νdio<40 (3)

Now assume that RM2a and RM2b are radii of curvature of the surfaces M2a and M2b of the second optical element M2 on the object side and the image side, and t is a thickness of the second optical element M2 on the optical axis. Nd is a refractive index of the material of the second optical element M2 to the d-line having the wavelength 587.6 nm. Moreover, the following conditions are assumed.

$$\begin{matrix}\frac{1}{( \frac{\vert RM 2 b \vert}{2} )} - \frac{1}{( \vert RM 2 a \vert + t )} = \frac{1}{{s}^{′}} & ( a 1 ) \\ \frac{( {s}^{′} - t ) \times Nd}{( Nd + 1 )} = Rapl & ( a 2 )\end{matrix}$$

Then, the following condition may be satisfied.

Rapl×0.8<|RM2a|<Rapl×1.2 (4)

Assume that d is a distance from the reflective rear surface M1a of the first optical element M1 to the reflective rear surface M2b of the second optical element M2, and L is a distance (overall length) from the object position to the image plane.

Then, the following condition may be satisfied.

L/d<4.5 (5)

The conditional expression (1) is effective for high optical performance over the visible light range. Unless the conditional expression (1) is satisfied, it becomes difficult to properly correct a variety of aberrations and to obtain the high optical performance over the visible light range while a high resolution is maintained over a wide image pickup range.

The conditional expressions (2) and (3) are effective in properly correcting a secondary chromatic aberration. Unless the conditional expressions (2) and (3) are satisfied, it becomes difficult to correct the secondary chromatic aberration.

The conditional expression (4) is effective for the surface M2a of the second optical element M2 on the object side to maintain a strong negative refractive power and to reduce an aberration over a wide wavelength range.

The expression (a1) defines an imaging relationship for the reflective surface M2b, and indicates that the object point is located at the center of curvature of the refractive surface M2a and the image point is located at the position apart from the reflective surface M2b by a distance s′. The expression (a2) indicates a radius of curvature Rapl with which the refractive surface M2a satisfies the aplanatic condition to the virtual object point located apart from the reflective surface M2b by the distance s′. The conditional expression (4) indicates a permissible shift of the refractive surface M2a from the radius of curvature Rapl for the aplanatic condition. The latitude of the conditional expression (4) is provided for balance with aberrations that occur in other surfaces. The conditional expression (4) may be satisfied for balance with the first optical element M1.

The aberrations of the refractive surface M2a can be restrained when these three expressions (a1), (a2), and (4) are satisfied. This is because when a ray initially enters the refractive surface M2a at an angle of approximately 0°, then is reflected on the reflective surface M2b, and exits from the refractive surface M2a, the radius of curvature of the refractive surface M2a satisfies the aplanatic condition. In addition, it becomes easier to reduce the aberrations over a wide wavelength range by reducing the aberrations on the refractive surface M2a having a largest effective diameter.

The conditional expression (5) is effective for a miniaturization of the entire system. Unless the conditional expression (5) is satisfied, it becomes difficult to restrain an obscuration ratio of light (or a nonuse ratio of light) in a catadioptric system while the overall length, which is a distance on an optical axis from the object plane to the image plane, is maintained as short as possible.

The numerical values of the conditional expressions (2), (3), (4), and (5) may be set as follows:

50<νcat (2a)

νdio<35 (3a)

Rapl×0.8<|RM2a|<Rapl (4a)

L1d<4.0 (5a)

The spherical aberration can be properly corrected without causing the chromatic aberration by providing an aspheric shape to each of the first optical element M1 and the second optical element M2. When the refractive surface M2a of the second optical element M2 has strong divergence, the light transmitting area near the center of the first optical element M1 as the positive lens can be made smaller than the effective diameter. Since the longitudinal chromatic aberrations of the catadioptric part CAT and the dioptric part DIO can be cancelled out, the refractive power of the convex or positive lens of the dioptric unit DIO can be made stronger and the overall length can be easily shortened. The secondary chromatic aberration can be reduced when the catadioptric part CAT is made of a glass material having a dispersion lower than that of the positive lens in the dioptric part DIO.

Since it is necessary to make the refractive power of the positive lens stronger than that of the negative lens in the normal dioptric optical system so as to form an image, the positive lens is made of a low-dispersion glass material and the negative lens is made of a high-dispersion glass material so as to correct the chromatic aberration. At this time, the secondary chromatic aberration appears since a changing ratio of the refractive index to a wavelength is different between the low-dispersion glass material and the high-dispersion glass material.

This embodiment can form an image by increasing the refractive power of the refractive surface M2b that causes no chromatic aberration even when the refractive power of the negative refractive surface M2a in the catadioptric part CAT is increased. The secondary chromatic aberration can be reduced by using a low-dispersion glass material (having a large Abbe number) for the glass material of the catadioptric part CAT. Since it is difficult to correct the lateral chromatic aberration in the catadioptric part CAT, this embodiment corrects the lateral chromatic aberration by using a high-dispersion glass material (having a small Abbe number) for part of the dioptric part DIO, thereby obtaining a wide observation range. This embodiment further corrects the lateral chromatic aberration by arranging the field lens FL on or near the intermediate image IM. When the conditional expression (1) is satisfied at this time, a variety of aberrations can be properly corrected in the overall visible light range while a high resolution is maintained over a wide area.

A variety of aberrations can be properly corrected for light from the light source 102 for fluorescent observation when the above conditional expressions are satisfied.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. For example, the light shield 121 may be arranged in the catadioptric part CAT and the aperture diaphragm AS may be arranged in the dioptric part DIO. In other words, this embodiment can maintain its effects as long as one of the catadioptric part CAT and the dioptric part DIO includes the aperture diaphragm AS and the other includes the light shield 121.

This embodiment can provide an image-pickup apparatus that can secure a wide image pickup area with a small configuration and to prevent excited light from entering an image sensor.

This application claims the benefit of Japanese Patent Application No. 2014-055090, filed Mar. 18, 2014, which is hereby incorporated by reference herein in its entirety.

What is claimed is:

1. An image-pickup apparatus comprising:
an illumination optical system configured to illuminate a sample with excited light;
an imaging optical system configured to form an optical image of the sample using fluorescent light from the sample; and
an image sensor configured to photoelectrically convert an optical image formed by the imaging optical system,
wherein the illumination optical system includes an adjustable diaphragm configured to adjust a light quantity of the excited light,
wherein the imaging optical system includes a light shield arranged at a position conjugate with a position of the adjustable diaphragm, and configured to shield light on and around an optical axis, and
wherein the following condition is satisfied:
A·M<B≦1.3A·M
where A is an aperture diameter of the adjustable diaphragm, B is a diameter of the light shield, and M is an imaging magnification of an optical system that includes part of the illumination optical system between the adjustable diaphragm and the light shield, and part of the imaging optical system between the adjustable diaphragm and the light shield.

2. The image-pickup apparatus according to claim 1, further comprising:
a plurality of light shields that have different sizes; and
a mover configured to move one of the plurality of light shields to the optical axis of the imaging optical system according to an aperture diameter of the adjustable diaphragm.

3. The image-pickup apparatus according to claim 1, wherein the imaging optical system includes a catadioptric optical system.

4. The image-pickup apparatus according to claim 3, wherein the imaging optical system includes:
a catadioptric part configured to condense light from the sample and to form an intermediate image of the sample; and
a dioptric part configured to reimage the intermediate image onto an image plane.

5. The image-pickup apparatus according to claim 4, wherein one of the catadioptric part and the dioptric part includes an aperture diaphragm and the other of the catadioptric part and the dioptric part includes the light shield.

6. The image-pickup apparatus according to claim 4, wherein the dioptric part includes a field lens at or near a position at which the intermediate image is formed.

7. The image-pickup apparatus according to claim 4, wherein the catadioptric part includes a first optical element and a second optical element in order from an object side,
wherein a surface of the first optical element on the object side has a first light transmitting area on and around the optical axis, and a first reflective area around the first light transmitting area, and
wherein a surface of the second optical element on an image side has a second light transmitting area on and around the optical axis, and a second reflective area around the second light transmitting area.

8. The image-pickup apparatus according to claim 7, wherein the following condition is satisfied:
νdio<νcat
where νcat is the smallest Abbe number among Abbe numbers of materials of the first optical element and the second optical element, and νdio is the smallest Abbe number among Abbe numbers of materials of a plurality of refractive optical elements in the dioptric part.

9. The image-pickup apparatus according to claim 7, wherein at least one of the following conditions is satisfied:
45<νcat; and
νdio<40
where νcat is the smallest Abbe number among Abbe numbers of materials of the first optical element and the second optical element, and νdio is the smallest Abbe number among Abbe numbers of materials of a plurality of refractive optical elements in the dioptric part.

10. The image-pickup apparatus according to claim 7, wherein the following condition is satisfied:
Rapl×0.8<|RM2a|<Rapl×1.2
where RM2a and RM2b are radii of curvature of surfaces of the second optical element on the object side and the image side, t is a thickness of the second optical element M2 on the optical axis, Nd is a refractive index of a material of the second optical element to the d-line, and the following conditions are established:
$$\frac{1}{( \frac{\vert RM 2 b \vert}{2} )} - \frac{1}{( \vert RM 2 a \vert + t )} = \frac{1}{{s}^{′}}$$
$$\frac{( {s}^{′} - t ) \times Nd}{( Nd + 1 )} = Rapl .$$

11. The image-pickup apparatus according to claim 7, wherein the following condition is satisfied:
L/d<4.5
where d is a distance on the optical axis from the surface of the first optical element on the object side to the surface of the second optical element on the image side, and L is a distance from an the object plane to the image plane.
